(19) United States
(12) Patent Application Publication
(10) Pub. No.: US 2022/0374310 A1
(43) Pub. Date: Nov. 24, 2022

(54) WRITE REQUEST COMPLETION NOTIFICATION IN RESPONSE TO PARTIAL HARDENING OF WRITE DATA

(71) Applicant: HEWLETT PACKARD ENTERPRISE DEVELOPMENT LP, Houston, TX (US)

(72) Inventors: Alex Veprinsky, San Jose, CA (US); Matthew S. Gates, Houston, TX (US); Lee L. Nelson, Boise, ID (US)

(21) Appl. No.: 17/323,345

(22) Filed: May 18, 2021

(51) Int. Cl. G06F 11/10; G06F 11/20; G06F 3/06

(52) U.S. Cl. CPC G06F 11/1076; G06F 11/2056; G06F 3/0619; G06F 3/0631; G06F 3/0689

(57) ABSTRACT

In some examples, a system receives a write request from a requester to write first data to a storage system that implements redundancy in which redundancy information is stored for data in the storage system. The system initiates the write to the storage system. The system determines that partial hardening for the first data has been achieved based on detecting that an information portion has been written to the storage system for the write request, the information portion being less than an entirety of the first data and the first parity information. In response to the determining of the partial hardening, the system notifies the requester of completion of the write request.

### BACKGROUND

A storage system can include a collection of storage devices to store data. In some examples, redundancy is provided as part of storing data into a storage system. The redundancy in some examples can be in the form of a mirror copy of the data that is stored in the storage system. For example, if a storage system includes two storage devices, primary data can be stored in a first storage device and a mirror copy of the primary data can be stored in a second storage device. In other examples, multiple mirror copies of the primary data can be stored in respective storage devices. If the primary data in the first storage device were to become corrupted for any reason, then a mirror copy can be used to recover the primary data.

As another example, parity information can be stored to protect data in the storage devices of a storage system. Parity information is computed based on multiple segments of data that are stored in respective storage devices of the storage system. If any segment(s) of data in a storage device (or multiple storage devices) were to become corrupted, then the segment(s) of data can be recovered using the parity information and non-corrupted segments of data.

### BRIEF DESCRIPTION OF THE DRAWINGS

Some implementations of the present disclosure are described with respect to the following figures.

FIG. 1 is a block diagram of an arrangement that includes a storage controller for a storage system, according to some examples.

FIG. 2 is a flow diagram of a process according to some examples.

FIG. 3 is a block diagram of a storage medium storing machine-readable instructions, according to some examples.

FIG. 4 is a block diagram of a system according to some examples.

FIG. 5 is a block diagram of a storage medium storing machine-readable instructions according to further examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a storage system can implement Redundant Array of Independent Disks (RAID) redundancy protection for data stored across storage devices of the storage system. There are several RAID levels. RAID 1 maintains a mirror copy of primary data, to provide protection for the primary data. For example, the primary data can be stored in a first storage device, and the mirror copy of the primary data can be stored in a second storage device. In other examples, multiple mirror copies of the primary data can be stored in respective second storage devices. A mirror copy of the primary data can be used to recover the primary data in case of corruption of the primary data, which can be due to a fault of hardware or machine-readable instructions, or due to other causes.

As used here, “primary data” refers to the original data that was written to a storage system. A mirror copy of the primary data is a duplicate of the primary data.

Other RAID levels employ parity information to protect primary data stored in the storage system. As used here, the term “parity information” refers to any additional information (stored in addition to data and computed based on applying a function to the data) that can be used to recover the primary data in case of corruption of the primary data.

Examples of RAID levels that implement parity information include RAID 3, RAID 4, RAID 5, RAID 6, and so forth. For example, RAID 5 employs a set of M+1 (M≥3) storage devices that stores stripes of data. A “stripe of data” refers to a collection of pieces of information across the multiple storage devices of the RAID storage system, where the collection of pieces of information include multiple segments of data (which collectively make up primary data) and associated parity information that is based on the multiple segments of data. For example, parity information can be generated based on an exclusive OR (or other function) applied on the multiple segments of data in a stripe of data.

For each stripe of data, parity information is stored in one of the M+1 storage devices, and the associated segments of data are stored in the remaining ones of the M+1 storage devices. For RAID 5, the parity information for different stripes of data can be stored on different storage devices; in other words, there is not one storage device that is dedicated to storing parity information. For example, the parity information for a first stripe of data can be stored on a first storage device, the parity information for a second stripe of data can be stored on a different second storage device, and so forth.

RAID 6 employs M+2 storage devices in which two of the storage devices are used to store respective pieces of parity information for a stripe of data. Whereas RAID 5 can recover from a fault of one storage device, RAID 5 can recover from a fault of two storage devices.

RAID 3 or 4 (as well as a RAID level above RAID 6) also employs parity information to protect primary data.

In a RAID N (N≥3) storage system, if any piece of information (segment of data or piece of parity information) in the stripe of data were to be corrupted for any reason, the remaining pieces of information in the stripe of data can be used to recover the corrupted piece of information.

A RAID system storage system can be managed by a storage controller. The storage controller can be part of the RAID storage system or can be separate from the RAID storage system. As used here, a “controller” can refer to a hardware processing circuit, which can include any or some combination of a microprocessor, a core of a multi-core microprocessor, a microcontroller, a programmable integrated circuit, a programmable gate array, or another hardware processing circuit. Alternatively, a “controller” can refer to a combination of a hardware processing circuit and machine-readable instructions (software and/or firmware) executable on the hardware processing circuit.

The storage controller can receive write requests from requesters, which can be in the form of electronic devices connected to the storage controller over a network. Examples of electronic devices include desktop computers, notebook computers, tablet computers, server computers, or any other type of electronic device that is capable of writing and reading data. In other examples, requesters can include programs (machine-readable instructions), humans, or other entities.

In some examples, when the storage controller receives a write request from a requester to write data to a RAID storage system, the storage controller can wait for completion of the write of all pieces of information for the write request to the respective storage devices of the RAID storage system before notifying the requester that the write request has been completed. A write request is “completed” if all pieces of information (including primary data as well as parity information or a mirror copy of the primary data) for the write request has successfully been stored in the storage devices of the RAID storage system.

Waiting for all of the pieces of information for each write request to be completed to the respective storage devices of the RAID storage system before responding with a write complete notification can result in relatively long delays in providing write complete notifications to requesters. For example, one (or multiple) of the storage devices of the RAID storage system may be exhibiting slow access speeds (e.g., due to high loading of the storage device(s) or faulty operation of the storage device(s)). A write operation is not considered complete until the respective piece(s) of information has (have) been written to the slower storage device(s). As a result, a requester may experience a delay in receiving a write completion notification for a write request, which can delay the operation of the requester.

A “write completion notification” can refer to any indication provided by a storage controller that a write of data for a write request has been completed.

Moreover, while waiting for the write operation to complete, the storage controller may not be able to free up resources associated with the write operation. For example, the storage controller may include a write cache or another memory that stores write data temporarily until the write data is committed to the persistent storage of the RAID storage system. If the write operation is not completed, the portion of the write cache or other memory used to store the respective write data may not be freed up for other write requests or for other purposes.

In accordance with some implementations of the present disclosure, a controller can provide an early notification of write completion to a requester in response to determining that a sufficient quantity of pieces of information for the write request have been written to storage devices of a storage system that supports data mirroring (e.g., RAID 1) or parity-based redundancy (e.g., RAID N, N≥3). The “sufficient” quantity of pieces of information for the write request refers to a partial portion of primary data and associated redundancy information (e.g., either parity information or a mirror copy of the primary data). The partial portion is made up of less than an entirety of the data and the associated redundancy information.

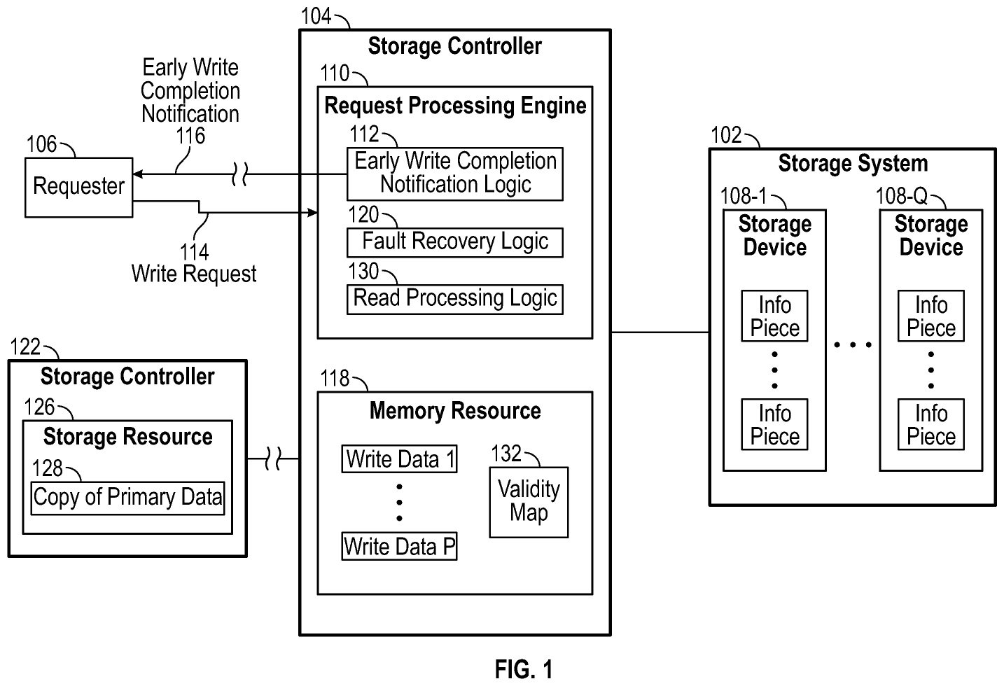

FIG. 1 is a block diagram of an example arrangement that includes a storage system 102 and a storage controller 104. The storage controller 104 manages access (read or write) of data stored in the storage system 102, in response to requests received from requesters, such as a requester 106. Although just one requester 106 is shown in FIG. 1, in other examples, multiple requesters can issue requests (including read requests and write requests) to the storage controller 104.

FIG. 1 shows the storage controller 104 as being separate from the storage system 102. In other examples, the storage controller 104 can be part of the storage system 102.

The storage system 102 includes storage devices 108-1 to 108-Q, where Q≥2. In examples where the storage system 102 implements RAID 1, one of the storage devices 108-1 to 108-Q is used to store primary data, and a number of other storage devices (different from the storage device used to store the primary data) is (are) used to store a mirror copy of the primary data (or multiple mirror copies of the primary data). In other examples where the storage system 102 implements a RAID level that employs parity information, storage devices 102-1 to 108-Q are used to store primary data segments and parity information.

As shown in FIG. 1, the information pieces (labeled “Info Piece” in FIG. 1) stored in the storage devices 108-1 to 108-Q include segments of primary data and redundancy information (e.g., a mirror copy of the primary data or parity information).

The storage controller 104 includes request processing engine 110 to process requests (e.g., write requests and read requests) from requesters, such as the requester 106. In response to a request, the request processing engine 110 can initiate a corresponding operation to perform a write or read with respect to the storage system 102. As used here, an “engine” can refer to a portion of the hardware processing circuit of the storage controller 104, or to machine-readable instructions executable by the storage controller 104.

Early Write Completion Notification

In accordance with some examples of the present disclosure, the request processing engine 110 includes an early write completion notification logic 112. A “logic” in the request processing engine 110 can refer to a portion of the hardware processing circuit or machine-readable instructions of the request processing engine 110.

The request processing engine 110 receives a write request (114) from the requester 106, such as over a network. The write request 114 is to write data X to the storage system 102.

In response to the write request 114, the request processing engine 110 initiates a write operation to the storage system 102, such as by sending a write command (or multiple write commands) corresponding to the write request 114 to the storage system 102, to write data X to the storage system 102.

As the storage system 102 completes writes of pieces of information for the write request 114 to the storage devices 108-1 to 108-Q, the storage system 102 can send respective indications back to the storage controller 104. For example, the storage system 102 can send indications as a segment or segments of data X (is) are committed to a storage device or multiple storage devices and as piece(s) of redundancy information is (are) committed to a storage device or multiple storage devices.

“Committing” a piece of information by the storage system 102 refers to writing the piece of information to a persistent storage medium of a storage device 108-i, i=1 to Q.

For example, if RAID 1 is used, then an indication can be provided by the storage system 102 to the storage controller 104 to indicate that data X has been committed to a storage device or a mirror copy of data X has been committed to another storage device. If RAID 1 is employed, the commitment of either data X or a mirror copy of data X to a storage device 108-i would allow data X to be recovered even if less than the entirety of data X and the mirror copy (or mirror copies) of data X have been committed to respective storage devices.

In the RAID 1 example, the early write completion notification logic 112 determines, based on the indications returned from the storage system 102 relating to commitment of respective pieces of information for the write request 114, that a sufficient quantity of the information pieces has been written to the storage devices 108-1 to 108-Q for the write request 114 to allow for recovery of data X in case of a fault. This determination by the early write completion notification logic 112 means that partial hardening of data for the write request 114 has occurred.

A “fault” can refer to a condition in which an operation to access data has been interrupted or was unable to proceed to full completion. The fault can be due to a hardware failure or error, a failure or error of machine-readable instructions, a failure or error in data transmission, or any other cause of an error.

Once the early write completion notification logic 112 determines that partial hardening for the write request 114 has occurred, the early write completion notification logic 112 can send an early write completion notification 116 to the requester 106. The early write completion notification 116 is “early” in the sense that the requester 106 is provided with a notification of write completion even though a partial portion of data X and the mirror copy of data X has been committed (i.e., both data X and the mirror copy of data X have not yet been written to persistent storage media of the storage devices 108-1 to 108-Q).

In examples in which the storage system 102 implements a RAID level that employs parity information, then the indications returned by the storage system 102 can include the following: an indication that a piece of parity information is committed, indications as segments of data X for the write request 114 are committed. Based on the indications, the early write completion notification logic 112 can make a determination of when partial hardening has occurred for data X.

For example, if the storage system 102 implements RAID 5 in which three segments of data (D1, D2, D3) are protected by parity information (P), then the early write completion notification logic 112 determines that partial hardening has occurred if any three of D1, D2, D3, and P have been committed to respective storage devices in the storage system 102. For example, partial hardening has occurred if D1, D3, and P are committed, but D2 is not yet committed.

As another example, if the storage system 102 implements RAID 6 in which three segments of data (D1, D2, D3) are protected by parity information pieces P1 and P2, then the early write completion notification logic 112 determines that partial hardening has occurred if any four of D1, D2, D3, P1, and P2 have been committed to respective storage devices in the storage system 102 (which is equivalent to completion of a RAID 5 storage operation).

Stated differently, the early write completion notification logic 112 can send the early write completion notification 116 for the write request 114 back to the requester 106 even though not all of the information pieces for the write request 114 have been committed to the storage devices 108-1 to 108-Q of the storage system 102 for full RAID protection.

More generally, if a partial information portion for the write request 114 has been committed to the storage devices 108-1 to 108-Q, where this partial information portion is sufficient to allow for recovery of data X in case of a fault, then partial hardening of data X is considered to have been achieved. Partial hardening occurs if a sufficient amount of the primary data and redundancy information have been committed to the storage devices 108-1 to 108-Q of the storage system 102 such that primary data can be recovered even if one of the storage devices 108-1 to 108-Q (or more than one of the storage devices 108-1 to 108-Q) were to become unavailable for any reason.

The storage controller 104 includes a memory resource 118, which can be used to store write data for respective write requests. In some examples, the memory resource 118 can include a write cache memory. In other examples, the memory resource 118 can include another type of memory of the storage controller 104. A “memory” can be implemented using a number (one or greater than one) of memory devices, such as dynamic random access memory (DRAM) devices, static random access memory (SRAM) devices, and so forth.

When a write request (e.g., the write request 114) is received by the request processing engine 110, the request processing engine 110 can post (insert) write data for the write request into the memory resource 118. As shown in FIG. 1, assuming there are multiple write requests being processed by the storage controller 104, multiple write data 1 to P (P≥2) have been written to the memory resource 118. The memory resource 118 is to temporarily store the write data for a given write request until partial hardening has occurred for the given write request.

In accordance with some implementations of the present disclosure, once partial hardening for the given write request, such as the write request 114, has been detected by the early write completion notification logic 112, the request processing engine 110 can proceed to free up a resource used for the write request 114. For example, freeing up a resource can include freeing up a portion of the memory resource 118 used to store write data for the given write request for which partial hardening has occurred. For example, the portion of the memory resource 118 storing the write data for the given write request can be flushed to a persistent storage in the storage system 102, can be unlocked so that write data for another write request can be written to the portion of the memory resource 118, and so forth.

Allowing the ability to detect partial hardening can provide several benefits in some examples. A requester (e.g., 106) provided with an early write completion notification (e.g., 116) can proceed to perform other activities without having to wait for actual full completion of a write request.

Also, freeing up resources at the storage controller 104 for a write request after detecting partial hardening allows the storage controller 104 to use the freed resources for other activities, such as to process other write requests. Effectively, once partial hardening is detected, the completion of an update of a RAID set (i.e., the commitment of all pieces of information for the write request at the storage system 102) can be performed in parallel with other activities of the storage controller 104 using the freed resources. Thus, even if the update of the RAID set were to proceed slowly due to a storage device 108-i experiencing slow access speeds, the storage controller 104 would not be slowed down once partial hardening has been detected and the storage controller 104 can proceed to use the freed resources for other activities.

A “RAID set” refers to the pieces of information for completing a write for a respective RAID level. For example, the RAID set for RAID 1 includes the primary data and the mirror copy(ies) of the primary data. The RAID set for RAID 5 includes the segments of the primary data and the associated parity information. The RAID set for RAID 6 includes the segments of the primary data and the associated pieces of parity information.

A “RAID set update” or an “update of a RAID set” refers to writing the pieces of information of a RAID set for a write request to the storage devices 108-1 to 108-Q of the storage system 102.

As discussed further below, the storage controller 104 can rely on other data redundancies to protect against fault of the storage system 102 before the RAID set update is complete (assuming that the fault caused a portion of the partially hardened information pieces to be lost). Note that if a fault of the storage system 102 before the RAID set update is complete does not cause loss of any of the information pieces that make up a partially hardened set, then the storage controller 104 would not have to rely on other data redundancies to recover data but instead can use the partially hardened set.

For example, assuming the storage system 102 uses RAID 5, and partial hardening has occurred when writing information pieces D1, D2, D3, and P for a given write request, a partially hardened set can include a subset of D1, D2, D3, and P that includes any three of the four information pieces. If the RAID set update for the given write request is unable to complete due to a fault, and the partially hardened set is still available, then the partially hardened set can be used to recover the data for the given write request.

However, if the RAID set update for the given write request is unable to complete due to a fault, and a portion of the partially hardened set is lost due to the fault, then the storage controller 104 can rely on other data redundancies to recover the data for the given write request (discussed further below).

Callback Indications to Requesters

In some examples, in addition to the early write completion notification 116, the early write completion notification logic 112 can provide, to requesters such as the requester 106, further callback indications relating to intermediate status(es) of RAID set updates for write requests. The callback indications can be in the form of messages or other indicators returned to the requesters. If a requester is an electronic device, then a callback indication can trigger the electronic device to present (e.g., display) a status relating to a RAID set update.

The callback indications sent back to the requester 106 can depend upon the RAID level used by the storage system 102. For example, if RAID 1 is used, then the early write completion notification logic 112 can provide the following: a first callback indication to the requester 106 when data X for the write request 114 has been committed to a first storage device, a second callback indication when a mirror copy of data X has been committed to a second storage device, and a third callback indication when all of the pieces of information relating to data X (data X plus the mirror copy(ies) of data X) have been committed to the respective storage devices 108-1 to 108-Q of the storage system 102. In this example, either the first or second callback indication is the early write completion notification 116.

As another example, if RAID 6 is implemented by the storage system 102, then the following callback indications can be sent by the early write completion notification logic 112 to the requester 106: a first callback indication when either of the two pieces of parity information have been committed, a second callback indication when the segments of data X have been committed, a third callback indication when a RAID 5 level of protection is available, i.e., the data segments have been committed and one parity information piece out of the two pieces of parity information have been committed, and a fourth callback indication can when both pieces of parity information and all the data segments of data X have been committed.

In other examples, other callback indications can be provided by the early write completion notification logic 112 responsive to other events associated with a RAID set update for a write request.

In some examples, a user or another entity (a program or machine) can specify what callback indications are of interest. For example, a user at an electronic device can register with the storage controller 104 that the user is interested in certain callback indications. The storage controller 104 can store registration information relating to the callback indications of interest, and can send the callback indications for a write request as events relating to a RAID set update for the write request unfold.

Fault Recovery

In some cases, a write operation (including a RAID set update) may be interrupted due to a fault, which may prevent all of the pieces of information for the given write request to be committed to the storage devices of the storage system 102. For example, an early write completion notification may have been provided back to the requester 106, at which point the requester 106 has assumed that the RAID set update for the write request sent by the requester 106 has been completed. As noted above, a partially hardened set of information pieces for the write request has been committed at the point that the early write completion notification was provided back to the requester 106.

However, a fault (e.g., a storage device of the storage system 102 is lost or a fault has occurred at the storage controller 104) may cause a portion of the partially hardened set to be lost, which can prevent data recovery for the write request, i.e., the storage controller 104 would be unable to reconstruct the primary data.

If the storage controller 104 detects that the RAID set update has been interrupted and loss of a portion of the partially hardened set has occurred, fault recovery logic 120 of the request processing engine 110 can perform a recovery operation to determine the parts of the RAID set that are missing and to construct such missing parts of the RAID set. For example, the fault recovery logic 120 can attempt to retrieve the available portions of the partially hardened set from the storage system 102, and identify the missing parts of the RAID set.

In some examples, the fault recovery logic 120 can leverage other data redundancies to assist in recovering the missing parts of the RAID set. The other data redundancies can include a copy of the primary data stored in the memory resource 118 or stored in another storage location.

For example, in addition to any pieces of information that are stored at the storage devices 108-1 to 108-Q for the RAID set, the fault recovery logic 120 can also access the corresponding copy of the write data in the memory resource 118 to obtain the missing parts of the RAID set. The copy of the write data in the memory resource 118 can be used to reconstruct the identified missing parts of the RAID set.

As another example, a copy of the primary data can be stored in another storage location, such as in another storage controller 122. For example, the storage controller 104 may be part of a redundant collection of storage controllers, where one of the storage controllers in the collection of storage controllers can be a backup storage controller for another storage controller. In the example shown in FIG. 1, the storage controller 122 may be a backup storage controller for the storage controller 104. The storage controllers 104 and 122 can communicate with one another over a network.

The backup storage controller 122 can store a copy 128 of the primary data for the write request 114 in a storage resource 126 of the storage controller 122. The storage resource 126 can include a memory resource or a persistent storage accessible by the storage controller 122.

The copy 128 of the primary data can be retrieved from the storage controller 122 by the fault recovery logic 120, for use in reconstructing the missing parts of the RAID set.

Read Request Processing During a RAID Set Update

During a RAID set update, the storage controller 104 may receive a read request to read data that is the subject of the RAID set update at the storage system 102. The read request may come from the requester 106 or another requester. For example, the early write completion notification 116 may cause the requester 106 to issue a read request for data X even though the RAID set update for data X may not be complete. However, because the RAID set update for data X is partially complete, some of the pieces of information of the RAID set may be awaiting update and thus not yet valid.

In some examples, a read processing logic 130 of the storage controller 104 can respond to the read request by accessing a validity map 132 (or more generally, metadata) to determine which pieces of information of the RAID set being updated are valid. The validity map 132 can be stored in the memory resource 118 of the storage controller 104, for example. As used here, a “map” can refer to any information that provides an indication of a validity of a piece of information stored in the storage devices 108-1 to 108-Q of the storage system 102.

As an example, assume data segments D1, D2, and D3 of data X are to be committed to the storage devices 108-1 to 108-Q for the write request 114. However, when the early write completion notification 116 is sent by the storage controller 104 back to requester 106, just two of the data segments D1, D2, and D3 may have been committed, while a third data segment has not yet been committed. If the storage controller 104 retrieves data from a storage location where the third data segment is to be stored, then the retrieved data may be stale data, since the third data segment has not yet been committed to the storage location in the RAID set update.

The validity map 132 can include indicators to indicate, for each stripe of data of the RAID set update, which storage locations contain valid data segments. Storage locations containing committed data segments for the RAID set update can have indicators set to a first value (e.g., logical “1”) to indicate that such storage locations contain valid data segments. However, any storage location for which a data segment has not yet been committed can be associated with an indicator in the validity map 132 that is set to a different second value (e.g., logical “0”) to indicate that the storage location does not contain valid data.

In some examples, the validity map 132 can be in the form of bitmaps including an array of bits that are settable to logical “1” and “0” to indicate whether or not a respective storage location contains valid data.

Once the read processing logic 130 has identified, based on the validity map 132, which data segments of the RAID set currently being updated are valid, the read processing logic 130 can return the valid data segments from the storage devices 108-1 to 108-Q to the requester 106. Any data segment of the RAID set that is currently being updated that is not valid is not returned by the read processing logic 130 to the requester 106. In some examples, the read processing logic 130 can wait for the RAID set update before responding with the remaining data segment(s), or alternatively, the read processing logic 130 can attempt to access the data segment(s) from another source, such as the memory resource 118 or the storage controller 122.

### Further Example Implementations

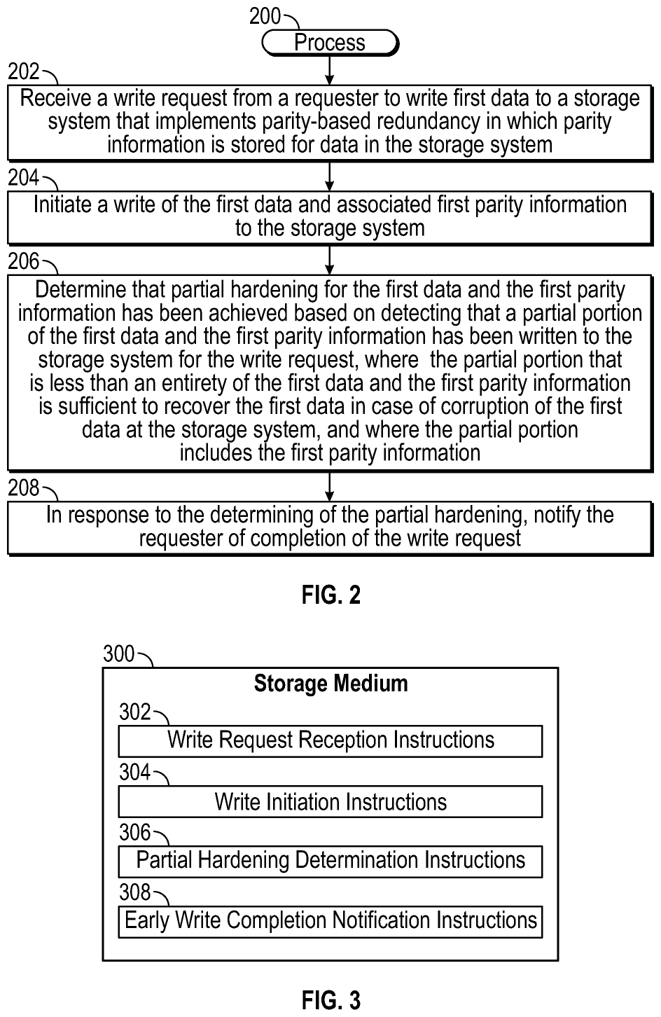

FIG. 2 is a flow diagram of a process 200 that can be performed by a storage controller, such as 104 in FIG. 1.

The process 200 includes receiving (at 202) a write request from a requester (e.g., 106 in FIG. 1) to write first data to a storage system (e.g., 102 in FIG. 1) that implements parity-based redundancy in which parity information is stored for data in the storage system. For example, the parity-based redundancy can include parity information for RAID N, N≥3.

Different examples for the RAID 1 case are discussed further below.

The process 200 includes initiating (at 204) a write of the first data and associated first parity information to the storage system. This write is part of a RAID set update to the storage devices of the storage system for the write request.

The process 200 includes determining (at 206) that partial hardening for the first data and the first parity information has been achieved based on detecting that a partial portion of the first data and the first parity information has been written to the storage system for the write request, where the partial portion that is less than an entirety of the first data and the first parity information is sufficient to recover the first data in case of corruption of the first data at the storage system, and where the partial portion includes the first parity information.

The process 200 includes, in response to the determining of the partial hardening, notifying (at 208) the requester of completion of the write request. An example of this notification is the early write completion notification 116 of FIG. 1.

FIG. 3 is a block diagram of a non-transitory machine-readable or computer-readable storage medium 300 storing machine-readable instructions that upon execution cause a controller (e.g., 104 in FIG. 1) to perform various tasks.

The machine-readable instructions include write request reception instructions 302 to receive a write request from a requester to write first data to a storage system that implements parity-based redundancy in which parity information is stored for data in the storage system.

The machine-readable instructions include write initiation instructions 304 to initiate the write to the storage system, which includes performing a RAID set update, in examples where the storage system implements RAID redundancy.

The machine-readable instructions include partial hardening determination instructions 306 to determine that partial hardening for the first data has been achieved based on detecting that an information portion has been written to the storage system for the write request, where the information portion includes first parity information for the first data and is less than an entirety of the first data and the first parity information.

In some examples, the partial hardening is determined prior to completing a write of the first data to the storage system (e.g., prior to the RAID set update completing).

The machine-readable instructions include early write completion notification instructions 308 to, in response to the determining of the partial hardening, notify the requester of completion of the write request.

In some examples, the machine-readable instructions can free up a resource allocated for the write request in response to the determining of the partial hardening. In further examples, the freeing up of the resource allocated for the write request is further in response to determining that a copy of the first data is available at another location, such as in the memory resource 118 or the storage controller 122 in FIG. 1.

In some examples, the machine-readable instructions receive a further write request from the requester to write second data to the storage system, initiate a further write for the further write request to the storage system, determine that partial hardening for the second data has been achieved based on detecting that a further information portion has been written to the storage system for the further write request, the further information portion including less than an entirety of the second data and second parity information for the second data, and in response to the determining of the partial hardening for the second data, notify the requester of completion of the further write request.

In some examples, the partial hardening for the second data is determined prior to completing a write of the second parity information to the storage system.

In some examples, after the determining of the partial hardening and the early notification write completion, the machine-readable instructions detect a data corruption associated with the first data prior to completing a write of the entirety of the first data and the first parity information to the storage system, and recover from the data corruption using a copy of the first data stored separately from storage devices of the storage system.

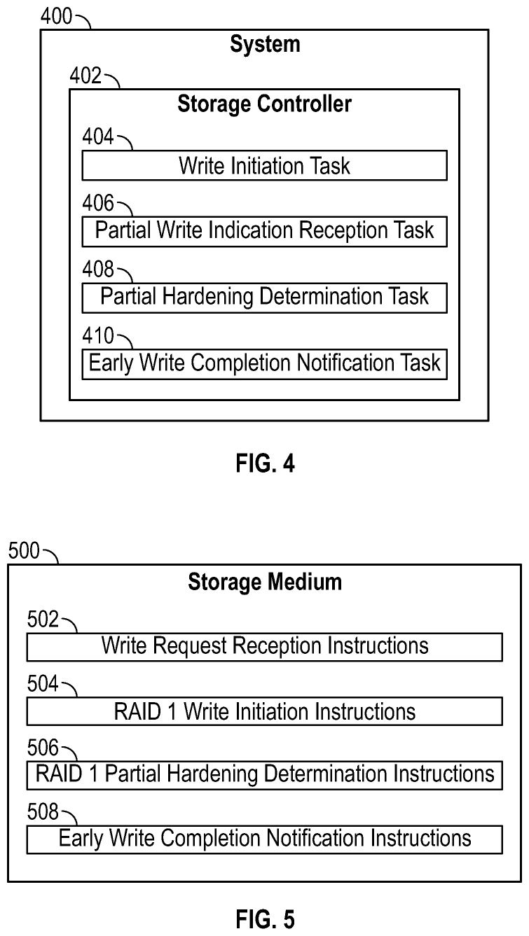

FIG. 4 is a block diagram of a system 400 according to some examples. The system 400 can include a computer or multiple computers. The system 400 includes a storage controller 402 to perform various tasks.

The storage controller 402 performs a write initiation task 404 that, in response to a write request from a requester, initiates a write of first data for the write request to a RAID storage system including storage devices that store write data and associated respective parity information.

The storage controller 402 performs a partial write indication reception task 406 that receives an indication of a partial write of information for the write request to the storage devices of the RAID storage system.

The storage controller 402 performs a partial hardening determination task 408 that determines, based on the indication, that the partial write of information is sufficient to enable recovery of the first data according to a RAID level of the RAID storage system, where the partial write of information includes a write of first parity information for the first data to a storage device of the RAID storage system, and a write of less than an entirety of the first data to the RAID storage system.

The storage controller 402 performs an early write completion notification task 410 that, in response to the determining, notifies the requester of completion of the write request.

FIG. 5 is a block diagram of a non-transitory machine-readable or computer-readable storage medium 500 that stores machine-readable instructions that upon execution cause a storage controller (e.g., 104 in FIG. 1) to perform various tasks.

The machine-readable instructions include write request reception instructions 502 to receive a write request from a requester to write first data to a storage system that implements RAID 1 redundancy in which data and a mirror copy of the data are stored in respective storage devices of the storage system.

The machine-readable instructions include RAID 1 write initiation instructions 504 to initiate the write to the storage system in which a RAID set including the first data and a mirror copy of the first data is updated to the storage devices of the storage system.

The machine-readable instructions include RAID 1 partial hardening determination instructions 506 to determine that partial hardening for the first data has been achieved based on detecting that a partial portion of the first data and a mirror copy of the first data has been written to the storage system for the write request, the partial portion being less than an entirety of the first data and the mirror of the first data. For example, RAID 1 partial hardening has occurred if an entirety of a mirror copy of the first data has been committed to the storage system for the write request (but an entirety of the first data has not yet been committed to the storage system). Alternatively, RAID 1 partial hardening has occurred if an entirety of the first data has been committed to the storage system for the write request (but an entirety of a mirror copy of the first data has not yet been committed to the storage system).

The machine-readable instructions include early write completion notification instructions 508 to, in response to the determining of the partial hardening, notify the requester of completion of the write request.

A storage medium (e.g., 300 in FIG. 3 or 500 in FIG. 5) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a controller to:
receive a write request from a requester to write first data to a storage system that implements parity-based redundancy in which parity information is stored for data in the storage system;
initiate the write to the storage system;
determine that partial hardening for the first data has been achieved based on detecting that an information portion has been written to the storage system for the write request, the information portion comprising first parity information for the first data and being less than an entirety of the first data and the first parity information; and
in response to the determining of the partial hardening, notify the requester of completion of the write request.

2. The non-transitory machine-readable storage medium of claim 1, wherein the partial hardening is determined prior to completing a write of the first data to the storage system.

3. The non-transitory machine-readable storage medium of claim 1, wherein the instructions upon execution cause the controller to:
receive a further write request from the requester to write second data to the storage system;
initiate a further write for the further write request to the storage system;
determine that partial hardening for the second data has been achieved based on detecting that a further information portion has been written to the storage system for the further write request, the further information portion comprising less than an entirety of the second data and second parity information for the second data; and
in response to the determining of the partial hardening for the second data, notify the requester of completion of the further write request.

4. The non-transitory machine-readable storage medium of claim 3, wherein the partial hardening for the second data is determined prior to completing a write of the second parity information to the storage system.

5. The non-transitory machine-readable storage medium of claim 1, wherein the instructions upon execution cause the controller to:
in response to the determining of the partial hardening, free up a resource allocated for the write request.

6. The non-transitory machine-readable storage medium of claim 5, wherein the freeing up of the resource comprises freeing up a memory portion allocated for the write request.

7. The non-transitory machine-readable storage medium of claim 5, wherein the instructions upon execution cause the controller to:
free up the resource allocated for the write request further in response to determining that a copy of the first data is available at another location.

8. The non-transitory machine-readable storage medium of claim 7, wherein the controller is a first controller, and wherein the another location comprises a storage associated with a second controller.

9. The non-transitory machine-readable storage medium of claim 1, wherein the instructions upon execution cause the controller to:
after the determining of the partial hardening and the notifying, detect a data corruption associated with the first data prior to completing a write of the entirety of the first data and the first parity information to the storage system; and
recover from the data corruption using a copy of the first data stored separately from storage devices of the storage system.

10. The non-transitory machine-readable storage medium of claim 9, wherein the copy of the first data is stored in a memory of the controller.

11. The non-transitory machine-readable storage medium of claim 9, wherein the controller is a first controller, and the copy of the first data is stored in a storage associated with a second controller.

12. The non-transitory machine-readable storage medium of claim 1, wherein the write request involves updating a plurality of data segments of the first data, and wherein the instructions upon execution cause the controller to:
receive a read request prior to a completion of a write of the plurality of data segments to the storage system;
in response to the read request, return valid data segments of the plurality of data segments as read data.

13. The non-transitory machine-readable storage medium of claim 12, wherein the instructions upon execution cause the controller to:
identify the valid data segments based on metadata associated with the plurality of data segments of the first data stored in the storage system.

14. The non-transitory machine-readable storage medium of claim 1, wherein the parity-based redundancy is Redundant Array of Independent Disks (RAID) N redundancy, where N≥3.

15. A system comprising:
a storage controller to:
in response to a write request from a requester, initiate a write of first data for the write request to a Redundant Array of Independent Disks (RAID) storage system including storage devices that store write data and associated respective parity information;
receive an indication of a partial write of information for the write request to the storage devices of the RAID storage system;
determine, based on the indication, that the partial write of information is sufficient to enable recovery of the first data according to a RAID level of the RAID storage system, wherein the partial write of information comprises a write of first parity information for the first data to a storage device of the RAID storage system, and a write of less than an entirety of the first data to the RAID storage system; and
in response to the determining, notify the requester of completion of the write request.

16. The system of claim 15, wherein the storage controller is to:
receive, from the RAID storage system, indications of completions of different stages of a write operation for the write request,
wherein the determining that the partial write of information is sufficient to enable recovery of the first data according to the RAID level is based on the indications.

17. The system of claim 15, wherein the RAID level is RAID level N, where N≥3.

18. The system of claim 15, wherein the storage controller is to:
in response to the determining of the partial hardening and that a copy of the first data is available at another location, free up a resource, of the storage controller, allocated for the write request.

19. A method of a controller, comprising:
receiving a write request from a requester to write first data to a storage system that implements parity-based redundancy in which parity information is stored for data in the storage system;
initiating a write of the first data and associated first parity information to the storage system;
determining that partial hardening for the first data and the first parity information has been achieved based on detecting that a partial portion of the first data and the first parity information has been written to the storage system for the write request, and the partial portion that is less than an entirety of the first data and the first parity information is sufficient to recover the first data in case of corruption of the first data at the storage system, wherein the partial portion includes the first parity information; and
in response to the determining of the partial hardening, notifying the requester of completion of the write request

20. The method of claim 19, wherein the parity-based redundancy comprises a Redundant Array of Independent Disks (RAID) redundancy of level N, where N≥3.

21. A non-transitory machine-readable storage medium comprising instructions that upon execution cause a controller to:
receive a write request from a requester to write first data to a storage system that implements Redundant Array of Independent Disks (RAID) 1 redundancy in which data and a mirror copy of the data are stored in respective storage devices of the storage system;
initiate the write to the storage system;
determine that partial hardening for the first data has been achieved based on detecting that a partial portion of the first data and a mirror copy of the first data has been written to the storage system for the write request, the partial portion being less than an entirety of the first data and the mirror of the first data; and
in response to the determining of the partial hardening, notify the requester of completion of the write request.
